(19) United States
(12) Patent Application Publication
(10) Pub. No.: US 2026/0357440 A1
(43) Pub. Date: Nov. 12, 2026

(54) SURFACE TREATMENT SOLUTION COMPOSITION FOR PLATED STEEL SHEET, PLATED STEEL SHEET SURFACE-TREATED USING SAME AND METHOD FOR MANUFACTURING THEREOF

(71) Applicant: POSCO CO., LTD, Pohang-si, Gyeongsangbuk-do (KR)

(72) Inventors: CHANG-HOON CHOI, Gwangyang-si, Jeollanam-do (KR); II-Choun Park, Gwangyang-si, Jeollanam-do (KR); Jong-Kook Kim, Gwangyang-si, Jeollanam-do (KR)

(73) Assignee: POSCO CO., LTD, Pohang-si, Gyeongsangbuk-do (KR)

(21) Appl. No.: 19/137,257

(22) PCT Filed: Nov. 28, 2023
(86) PCT No.: PCT/KR2023/019354

§ 371 Date: Jun. 9, 2025

(30) Foreign Application Priority Data
Dec. 12, 2022 (KR) 10-2022-0172956

(51) Int. Cl. C23F 11/18; C09D 1/00; C09D 5/08; C09D 7/63; C22C 18/04

(52) U.S. Cl. CPC C23F 11/185; C09D 1/00; C09D 5/084; C09D 7/63; C22C 18/04

(57) ABSTRACT

The present invention relates to: a surface treatment solution composition capable of enhancing the corrosion resistance, lubricity, etc, of a zinc alloy plated steel sheet; a plated steel sheet surface-treated using same; and a method for manufacturing of the plated steel sheet.

### TECHNICAL FIELD

The present disclosure relates to a surface treatment solution composition which may improve corrosion resistance, lubricity, or the like, of a plated steel sheet used for a building material, a plated steel sheet surface-treated using the same, and a method for manufacturing the plated steel sheet.

### BACKGROUND ART

A plated steel sheet used as a building material may require high corrosion resistance, and for example, high corrosion resistance hot-dip plated steel sheets including a plating layer containing zinc (Zn), magnesium (Mg), and aluminum (Al) may be widely used. The high corrosion resistance hot-dip plated steel sheets may have excellent red rust corrosion resistance.

However, most of an exposed surface of the high corrosion resistance hot-dip plated steel sheet may be formed of zinc or zinc alloy, such that, when the steel sheet is exposed to a general environment, especially a wet atmosphere, a point-shaped corrosion defect easily occur on the surface, and the exterior may deteriorate.

To address this problem, as for most plated steel sheets, a surface treatment solution may be applied to the surface to suppress the formation of white rust caused by corrosion of the plating layer. Generally, corrosion resistance and blackening resistance have been ensured by performing hexavalent chromium or chromate treatment on a plated steel sheet. However, since hexavalent chromium has been designated as a hazardous environmental substance, regulations on the use of hexavalent chromium have currently been strengthened. Further, when hexavalent chromium is used as a surface treatment agent for a plated steel sheet, defects in which the surface of the steel sheet turns black or black spots may occur.

Thus, currently, a method of ensuring corrosion resistance and blackening resistance of the plated steel sheet by coating a surface treatment solution composition containing trivalent chromium on the plated steel sheet may be applied. For example, cited documents 1 to 3 disclose a method of chemical treatment by immersing a steel sheet in a composition containing trivalent chromium, and corrosion resistance and blackening may be ensured, but the immersion time may be relatively long for application to the continuous process of a steel mill, and the chemical treatment method may have problems such as reduced fingerprint resistance.

Also, cited documents 4 and 5 disclose that, by coating a composition containing chromium on a plated steel sheet by spraying or roll coater, the steel sheet may be applied to the continuous line of a steel mill and fingerprint resistance may be ensured. However, since the composition contain porous silica components, the steel sheet may not be suitable for Mg, Al alloys prone to discoloration in a humid atmosphere. Also, porous silica may have strong hygroscopic properties, which may cause rapid discoloration in a Zn—Mg—Al alloy steel sheet.
(Cited document 1) Korean Laid-Open Patent Publication No. 10-2006-0123628
(Cited document 2) Korean Laid-Open Patent Publication No. 10-2005-0052215
(Cited document 3) Korean Laid-Open Patent Publication No. 10-2010-0106031
(Cited document 4) Korean Laid-Open Patent Publication No. 10-2004-0046347
(Cited document 5) Korean Laid-Open Patent Publication Tuk Gae No. 2002-069660

### DETAILED DESCRIPTION OF PRESENT DISCLOSURE

### Technical Problems to Solve

An embodiment of the present disclosure is to provide a solution composition which may, by controlling a composition of a coating solution applied to a surface of a plated steel sheet, preferably a ternary alloy plated steel sheet, suppress generation of white rust in the early stage of corrosion, and may ultimately reduce a rate of reduction of a plating layer by a sacrificial method, and may slow down a corrosion rate of a base steel, thereby improving long-term corrosion resistance, a plated steel sheet surface-treated using the same and a method for manufacturing the same.

The subject matter of the present disclosure is not limited to the above-described contents. The subject matter of the present disclosure may be understood from the entire contents of this specification, and a person having ordinary skill in the technical field to which the present disclosure belongs may have no difficulty in understanding the additional subject matter of the present disclosure.

### Solution to Problem

According to an embodiment of the present disclosure, provided is a surface treatment solution composition comprising 1 to 10 weight % of a trivalent chromium compound,
0.1 to 5 weight % of an acidity regulator,
1 to 20 weight % of an adhesion improver,
1 to 20 weight % of a corrosion resistance improver,
0.1 to 5.0 weight % of a point corrosion improver,
1 to 10 weight % of a long-term corrosion resistance improver,
0.1 to 3.0 weight % of a lubricant,
1 to 20 weight % of a co-solvent, and a remainder of solvent.

The trivalent chromium compound may be one or more selected from a group consisting of chromium sulfate, chromium nitrate, chromium phosphate, chromium fluoride and mixtures thereof.

The acidity regulator may be one or more selected from a group consisting of phosphoric acid, nitric acid, sulfuric acid, hydrofluoric acid, hydrochloric acid, (NH₄)H₂PO₄, (NH₄)₂HPO₄, NaH₂PO₄, Na₂HPO₄, phytic acid, glycolic acid, lactic acid, acetic acid, oxalic acid and mixtures thereof.

The adhesion improver may be one or more selected from a group consisting of vinylmethoxy silane, vinyltrimethoxy silane (VTMS), vinylepoxy silane, vinyltriepoxy silane, 3-aminopropyltriepoxy silane, 3-glycidoxypropyltrimethoxy silane, 3-metaglyoxypropyltrimethoxy silane, γ-glycidoxypropyltriethoxysilane, γ-glycidoxytrimethyldimethoxysilane, N-(3-(trimethoxysilyl)propyl)ethylenediamine (AEAPTMS), 2-(3,4-Epoxycyclohexyl)ethyltrimethoxysilane, 2-(3,4-Epoxycyclohexyl)ethyltriethoxysilane, 3-(2,3-Epoxypropoxy)propyltrimethoxysilane, 3-(2,3-Epoxypropoxy)propyltriethoxysilane, 3-(2,3-Epoxypropoxy)propylmethyldiethoxysilane, 3-(2,3-Epoxypropoxy)propylmethyldimethoxysilane, 3-Aminopropyltriethoxysilane, 3-Aminopropyltrimethoxysilane, 3-Amonopropylmethydiethoxysilane, N-(2-Aminoethyl-3-aminopropyl)methyldimethoxysilane, N-(2-Aminoethyl-3-aminopropyl)trimethoxysilane, diethylenetriaminopropyltrimethoxysilane, 3-Ureidopropyltrimethoxysilane, N-Phenylaminopropyltrimethoxysilane, (3-Glycidyloxypropyl)trimethoxysilane(GPTMS), and methyltrimethoxysilane(MTMS).

The corrosion resistance improver may be one or more selected from a group consisting of vanadyl acetylacetonate, ammonium metavanadate, potassium metavanadate, sodium metavanadate, vanadium trioxide, vanadium acetylacetonate, ammonium metavanadate, silicon oxide and mixtures thereof.

The point corrosion improver may be one or more selected from a group consisting of ethylenediamine, hexamethylenediamine, trimethylamine, methylamine, diphenylamine, ethyleneamine, aniline, toluidine, piperidine, aziridine, pyridine, alanine, propylamine, diisopropylamine, monoisopropylamine, dibutylamine, dipropylamine and mixtures thereof.

The long-term corrosion resistance improver may be one or more selected from a group consisting of chromium chloride anhydrous, chromium chloride pentahydrate, chromium chloride hexahydrate, chromium chloride nonahydrate and mixtures thereof.

The lubricant may be one or more selected from a group consisting of polytetrafluoroethylene (PTFE), polyethylene (PE), carnauba wax and mixtures thereof.

The co-solvent may be one or more selected from a group consisting of ethanol, isopropyl alcohol, methanol, tallow alcohol, 2-butoxyethanol, diethylene glycol monobutyl ether and mixtures thereof.

The solvent may be water.

According to an embodiment of the present disclosure, provided is a surface-treated plated steel sheet comprising a steel sheet;
a plating layer formed on at least one surface of the steel sheet; and
a surface-treated coating layer formed on the plating layer,
wherein the surface-treated coating layer is formed by above mentioned solution composition.

The plating layer may comprise, by weight %, magnesium (Mg): 4.0 to 7.0%, aluminum (Al): 11.0 to 19.5%, and a balance of Zn and inevitable impurities.

The plating layer may satisfy relational expression 1 as below:

0.26≤I(110)/I(103)≤0.65 [Relational expression 1]
where I(110) represents X-ray diffraction integral intensity of an (110) plane crystal peak for a MgZn₂ phase, and I(103) represents X-ray diffraction integral intensity of an (103) plane crystal for a MgZn₂ phase.

The surface-treated coating layer may have a thickness of 0.1 to 2.0 μm.

According to an embodiment of the present disclosure, provided is a method for manufacturing a surface-treated plated steel sheet comprising providing a zinc alloy plated steel sheet having a plating layer formed on at least one surface thereof;
coating the plating layer with above mentioned solution composition; and
drying the coated steel sheet.

The coating may be performed by a method selected from a group consisting of bar coating, roll coating, spraying, dipping, spray squeezing and dipping squeezing.

The drying may be performed in a temperature range of 40 to 280 °C based on a peak metal temperature (PMT) of the steel sheet.

### Advantageous Effects of Invention

According to an aspect of the present disclosure, a surface treatment solution composition which may, by adjusting a composition of a coating solution applied to a surface of a high-temperature plated steel sheet, slow down formation of white rust in the early stages of corrosion, and may also ultimately slow down a corrosion rate of a plating layer by a sacrificial method, thereby improving long-term corrosion resistance may be provided.

According to an aspect of the present disclosure, a plated steel sheet having excellent corrosion resistance, machining corrosion resistance, pipe forming oil invasiveness, alkali resistance, point corrosion resistance, blackening resistance and long-term corrosion resistance, and no the foreign object defect may be provided.

The various beneficial advantages and effects of the present disclosure are not limited to the above-described contents, and will be more easily understood in the process of describing the specific embodiments of the present disclosure.

### BEST MODE FOR INVENTION

The terms used in this specification are intended to describe the present disclosure and are not intended to limit the present disclosure. Also, an expression used in the singular encompasses the expression of the plural, unless it has a clearly different meaning in the context.

The meaning of “including” or “comprising” used in this specification is to specify a configuration and does not exclude the presence or addition of other configurations.

Unless otherwise indicated, all terms, including technical and scientific terms, used in this specification may mean the same as commonly understood by a person of ordinary skill in the art to which the present disclosure belongs. The terms defined in the dictionary are interpreted to have a meaning consistent with the relevant cited document and the present disclosure.

Hereinafter, the present disclosure is described in detail below.

First, a surface treatment solution composition for a plated steel sheet according to an aspect of the present disclosure is described in detail.

The solution composition according to the present disclosure may comprise 1 to 10 weight % of a trivalent chromium compound, 0.1 to 5 weight % of an acidity regulator, 1 to 20 weight % of an adhesion improver, 1 to 20 weight % of a corrosion resistance improver, 0.1 to 5.0 weight % of a point corrosion improver, 1 to 10 weight % of a long-term corrosion resistance improver, 0.1 to 3.0 weight % of a lubricant, 1 to 20 weight % of a co-solvent, and a remainder of solvent.

A content of the solution composition according to the present disclosure may be based on 100 weight %.

As will be described in detail below, the solution composition may form a coating layer on at least one surface of a substrate to which the composition may be applied. In the present disclosure, the substrate may be the aforementioned plated steel sheet, for example, a zinc-based plated steel sheet, and as a non-limiting example, a Zn—Mg—Al ternary alloy plated steel sheet.

In the description below, each component included in the solution composition may be described in detail.

### 1 to 10 Weight % of Trivalent Chromium Compound (Hereinafter, %)

The trivalent chromium compound mainly may form an insoluble passive film on the surface of the steel sheet, thereby improving corrosion resistance by a barrier effect.

When the content of the trivalent chromium compound in the solution composition of the present disclosure is less than 1%, a solid insoluble passive film may not be sufficiently formed, such that moisture penetrating into the surface of the steel sheet may not be effectively blocked, and accordingly, corrosion resistance may not be ensured. When the content thereof exceeds 10%, the foreign object defect may occur due to the excessive chromium component.

In the present disclosure, the type of the trivalent chromium compound is not particularly limited, and preferably, the trivalent chromium compound may be one or more selected from a group consisting of chromium sulfate, chromium nitrate, chromium phosphate, chromium fluoride, and mixtures thereof.

### 0.1 to 5% of Acidity Regulator

In the solution composition of the present disclosure, the acidity regulator may adjust the pH of the solution such that the components in the composition may be present stably in the solution, may react appropriately under the coating conditions and may stably form a passive film.

When the content of the acidity regulator is less than 0.1%, the pH of the solution may increase and stability of the solution may deteriorate, and when the content thereof exceeds 5%, corrosion resistance, or the like, may not be ensured due to residual acid after drying.

The type of the acidity regulator is not specifically limited in the present disclosure, and preferably, the acidity regulator may be one or more selected from a group consisting of phosphoric acid, nitric acid, sulfuric acid, hydrofluoric acid, hydrochloric acid, (NH₄)H₂PO₄, (NH₄)₂HPO₄, NaH₂PO₄, Na₂HPO₄, phytic acid, glycolic acid, lactic acid, acetic acid, oxalic acid and mixtures thereof.

### 1 to 20% of Adhesion Improver

In the solution composition of the present disclosure, the adhesion improver may be combined with the trivalent chromium compound, or the like, and may also be combined with a steel sheet and may improve adhesion and corrosion resistance of the coating layer.

When the content of this adhesion improver is less than 1%, sufficient adhesion with the steel sheet may not be ensured, which may cause the foreign object defect. When the content thereof exceeds 20%, the amount remaining after the film formation may be excessive, which may not ensure corrosion resistance, or the like.

In the present disclosure, the type of the adhesion improver may not be specifically limited, and preferably, the adhesion improver may be one or more selected from a group consisting of vinylmethoxy silane, vinyltrimethoxy silane (VTMS), vinylepoxy silane, vinyltriepoxy silane, 3-aminopropyltriepoxy silane, 3-glycidoxypropyltrimethoxy silane, 3-metaglyoxypropyltrimethoxy silane, γ-glycidoxypropyltriethoxysilane, γ-glycidoxytrimethyldimethoxysilane, N-(3-(trimethoxysilyl)propyl)ethylenediamine (AEAPTMS), 2-(3,4-Epoxycyclohexyl)ethyltrimethoxysilane, 2-(3,4-Epoxycyclohexyl)ethyltriethoxysilane, 3-(2,3-Epoxypropoxy)propyltrimethoxysilane, 3-(2,3-Epoxypropoxy)propyltriethoxysilane, 3-(2,3-Epoxypropoxy)propylmethyldiethoxysilane, 3-(2,3-Epoxypropoxy)propylmethyldimethoxysilane, 3-Aminopropyltriethoxysilane, 3-Aminopropyltrimethoxysilane, 3-Amonopropylmethydiethoxysilane, N-(2-Aminoethyl-3-aminopropyl)methyldimethoxysilane, N-(2-Aminoethyl-3-aminopropyl)trimethoxysilane, diethylenetriaminopropyltrimethoxysilane, 3-Ureidopropyltrimethoxysilane, N-Phenylaminopropyltrimethoxysilane, (3-Glycidyloxypropyl)trimethoxysilane(GPTMS), and methyltrimethoxysilane(MTMS).

### 1 to 20% of Corrosion Resistance Improver

In the solution composition of the present disclosure, the corrosion resistance improver may fill the gap present between the trivalent chromium compound and the adhesion improver, and may form a passive film, thereby suppressing corrosion generation.

When the content of the corrosion resistance improver is less than 1%, it may be difficult to ensure corrosion resistance because the passive film is not sufficiently formed. When the content thereof exceeds 20%, solution stability may be reduced due to excessively high solid content.

In the present disclosure, the type of the corrosion resistance improver may not be specifically limited, and preferably, the corrosion resistance improver may be one or more selected from a group consisting of vanadyl acetylacetonate, ammonium metavanadate, potassium metavanadate, sodium metavanadate, vanadium trioxide, vanadium acetylacetonate, ammonium metavanadate, silicon oxide and mixtures thereof.

### 0.1 to 5.0% of Point Corrosion Improver

In the solution composition of the present disclosure, the point corrosion improver may minimize point corrosion occurring in the form of point by preventing local penetration of corrosion factors together with the corrosion resistance improver.

In the solution composition of the present disclosure, when the content of the point corrosion improver is less than 0.1%, point corrosion may occur because local penetration of corrosion factors is not blocked. When the content thereof exceeds 5.0%, the pH of the solution may rise excessively and stability of the solution may deteriorate.

In the present disclosure, the type of the point corrosion improver may not be specifically limited, and preferably, the point corrosion improver may be one or more selected from a group consisting of ethylenediamine, hexamethylenediamine, trimethylamine, methylamine, diphenylamine, ethyleneamine, aniline, toluidine, piperidine, aziridine, pyridine, alanine, propylamine, diisopropylamine, monoisopropylamine, dibutylamine, dipropylamine and mixtures thereof.

### 1 to 10% of Long-Term Corrosion Resistance Improver

In the solution composition of the present disclosure, the long-term corrosion resistance improver may combine with the corrosion products of the zinc alloy plating layer during the corrosion process after coating, and may activate formation of simonkolleite, such that long-term corrosion resistance of the zinc alloy (e.g., ternary system zinc alloy) plating plate may improve.

When the content of the long-term corrosion resistance improver is less than 1%, contribution to the formation of simonkolleite may be insufficient, such that long-term corrosion resistance may not be improved. When exceeding 10%, the foreign object defect may occur due to the excessive chromium component.

In the present disclosure, the type of the long-term corrosion resistance improver may not be particularly limited, and preferably, the long-term corrosion resistance improver may be one or more selected from a group consisting of chromium chloride anhydride, chromium chloride pentahydrate, chromium chloride hexahydrate, chromium chloride nonahydrate, and mixtures thereof.

### 0.1 to 3.0% of Lubricant

In the solution composition of the present disclosure, the lubricant may improve slipperiness of the steel sheet surface, may improve workability, and may suppress the foreign object defect.

When the content of the lubricant is less than 0.1%, slipperiness of the steel sheet surface may be insufficient, which may cause the foreign object defect. When the content thereof exceeds 3.0%, solution stability may be reduced due to the excessively high content of the lubricant.

In the present disclosure, the type of the lubricant is not specifically limited, and preferably, the lubricant may be one or more selected from a group consisting of polytetrafluoroethylene (PTFE), polyethylene (PE), carnauba wax, and mixtures thereof.

### 1 to 20% of a Co-Solvent

In the solution composition of the present disclosure, the co-solvent may adjust the volatilization rate of the solvent during the drying process in the coating process, thereby suppressing defects on the surface of the passive film after drying.

When the content of the co-solvent is less than 1%, the effect of adjusting the volatilization rate during drying may be insignificant, such that the evaporation rate of the main solvent may rapidly boil at the boiling point, which may cause surface defects referred to as popping, and accordingly, problems such as reduced corrosion resistance may occur. When the content thereof exceeds 20%, stability of the solution may be reduced due to rapid changes in viscosity and density of the solution.

In the present disclosure, the type of the co-solvent may not be specifically limited, and preferably, the co-solvent may be one or more selected from a group consisting of ethanol, isopropyl alcohol, methanol, tallow alcohol, 2-butoxyethanol, diethylene glycol monobutyl ether, and mixtures thereof.

### Solvent

The solution composition in the present disclosure may include a solvent as a residual component, and water (distilled water, deionized water) may be used as the solvent in the present disclosure.

In the description below, a surface-treated steel sheet including a predetermined coating layer by surface-treating with the above-described solution composition according to another aspect of the present disclosure may be specifically described.

The composition in the present disclosure may be a plated steel sheet, for example, a zinc-based plated steel sheet, and preferably, a Zn—Mg—Al ternary alloy plated steel sheet may be surface-treated.

That is, the surface-treated plated steel sheet in the present disclosure may include a steel sheet; a plating layer formed on at least one surface of the steel sheet; and a surface-treated coating layer formed on the plating layer. Here, the steel sheet may be a base steel sheet from which a plated steel sheet may be obtained, and in particular, any steel sheet from which a ternary system (Zn—Mg—Al system) zinc-plated steel sheet may be obtained may be used.

For example, the composition of the Zn—Mg—Al system plating layer may include, by weight %, magnesium (Mg): 4.0 to 7.0%, aluminum (Al): 11.0 to 19.5%, a balance of Zn and inevitable impurities.

Magnesium (Mg) in the plating layer may improve corrosion resistance of the plated steel sheet, and to ensure excellent corrosion resistance targeted in the present disclosure, the content thereof may be 4.0% or more, preferably. However, when the content of Mg is excessive, dross may be generated in the plating bath and intermetallic compounds having high hardness may be excessively formed in the plating layer, which may deteriorate bendability of the steel sheet, and thus, the content thereof may be limited to 7.0%.

As the content of Mg may be 4.0% or more, dross may be generated due to Mg oxidation in the plating bath. Considering this, the aluminum (Al) may be included by 11.0% or more. However, when the content of Al is excessive, the melting point of the plating bath may increase, and accordingly, the operating temperature may excessively increase, such that problems due to high-temperature work such as erosion of the plating bath structure and degeneration of the steel sheet may occur. Thus, the content of Al may be limited to 19.5% or less, preferably.

The remainder composition other than Mg and Al may be zinc (Zn), and inevitable impurities may be unintentionally mixed in the process of manufacturing the plated steel sheet having a Zn—Mg—Al plating layer. The inevitable impurities may be easily understood by those skilled in the art.

The structure of the Zn—Mg—Al plating layer described above may satisfy [Relational expression 1] as below, preferably.

0.26≤I(110)/I(103)≤0.65 [Relational expression 1]

(In relational expression 1, I(110) represents X-ray diffraction integral intensity of an (110) plane crystal peak for a MgZn₂ phase, and I(103) represents X-ray diffraction integral intensity of an (103) plane crystal for a MgZn₂ phase.)

Bendability, whiteness, or the like, of the plated steel sheet may be ensured by controlling the MgZn₂ phase of the Zn—Mg—Al system plating layer with [Relational expression 1].

When the value defined by [Relational expression 1] is less than 0.26, the presence ratio of (103) plane crystal for MgZn₂ phase as compared to (110) plane crystal for MgZn₂ phase may be excessive, such that bendability or whiteness may be insufficient. When the value exceeds 0.65, the presence ratio of (103) plane crystal for MgZn₂ phase as compared to (110) plane crystal for MgZn₂ phase may be excessive, such that such that the increase in diffuse reflection may not be induced, and accordingly, whiteness may be insufficient.

In this case, the I(110) may have an integrated intensity value in the range of 120 to 200, and the I(103) may have an integrated intensity value in the range of 240 to 300. As described above, the value of [Relational expression 1] may be satisfied within each range, preferably.

An upper portion of the Zn—Mg—Al plating layer described above may include a coating layer formed by coating the composition of the present disclosure in a solution state, and in this case, the coating layer preferably may have a thickness of 0.1 to 2.0 μm.

When the thickness of the coating layer is less than 0.1 μm, the surface treatment solution composition may be thinly applied to the rough acid portion of the surface of the plated steel sheet, such that corrosion resistance may be reduced. When the thickness exceeds 2.0 μm, the coating layer may increase, which may deteriorate workability and may increase the cost of solution treatment, which may be economically disadvantageous.

Here, the thickness may refer to the thickness after drying.

Furthermore, a method for manufacturing a surface-treated steel sheet using the composition in the present disclosure may be described.

More specifically, the method may include providing a plated steel sheet having a plating layer formed on at least one surface; coating the above-described solution composition on the plating layer; and drying the coated steel sheet.

Since the composition of the present disclosure may be applied to the steel sheet in a solution state using a commonly used coating method, there may be no particular limitation.

For example, the coating process may be performed by selecting one of the methods such as bar coating, roll coating, spraying, dipping, spray squeezing, and dipping squeezing.

Preferably, the process of drying the coated steel sheet with the composition may be performed in a temperature range of 40 to 280 °C based on the peak metal temperature (PMT) of the steel sheet.

When the peak metal temperature of the steel sheet is less than 40 °C, formation of a solid passive film structure may be insufficient, which may deteriorate corrosion resistance and blackening resistance. When the temperature exceeds 280 °C, hardness of the passive film may increase excessively, such that corrosion resistance of the processed portion may deteriorate and surface quality may deteriorate, such as yellowing due to excessive heat.

The steel sheet on which the drying is completed may have a coating layer having a thickness of 0.1 to 2.0 μm after drying.

In the present disclosure, the means for performing the drying are not specifically limited, but facilities such as an induction oven or a hot air dryer may be used, and as for the conditions of the facilities, general conditions may be used.

### MODE FOR INVENTION

### Embodiment

Hereinafter, the present disclosure may be described in greater detail through embodiments. However, these embodiments are only for exemplifying the implementation of the present disclosure, and the present disclosure is not limited to the embodiments. This is because the scope of the rights of the present disclosure is determined by the matters described in the claims and subject matters reasonably inferred therefrom.

First, to measure the properties of the surface treatment solution composition, the solution composition was prepared using the materials as below. Phosphoric acid was added to distilled water as an acidity regulator, and chromium nitrate, which is a trivalent chromium compound, and chromium chloride nonahydrate, which is a long-term corrosion resistance improver, were added at about 40 °C, and stirred for about 30 minutes. In the same manner, GPTMS, an adhesion improver, was added, and silicon oxide, which is a corrosion resistance improver, ethylenediamine, which is a point corrosion improver, ethanol, which is a co-solvent, and polyethylene (PE), which is a lubricant, were added at 30-minute intervals while stirring.

In this case, the content (weight %, the remainder is solvent) of each component is listed in Tables 1 and 2 below.

TABLE 1

| | | | | | | Long- | | |
|---|---|---|---|---|---|---|---|---|
| | | | | | | term | | |
| | Trivalent | | | Corrosion | Point | corrosion | | |
| | chromium | Acidity | Adhesion | resistance | corrosion | resistance | | co- |
| Classification | compound | regulator | improver | improver | improver | improver | Lubricant | solvent |
| Inventive | 4.0 | 3.9 | 16.5 | 10.3 | 4.6 | 9.8 | 1.5 | 1.2 |
| example 1 | | | | | | | | |
| Inventive | 8.3 | 2.3 | 14.4 | 10.6 | 3.4 | 6.7 | 2.2 | 4.6 |
| example 2 | | | | | | | | |
| Inventive | 2.0 | 4.4 | 5.6 | 13.5 | 3.6 | 4.9 | 1.1 | 3.8 |
| example 3 | | | | | | | | |
| Inventive | 9.6 | 4.2 | 19.3 | 7.4 | 1.8 | 7.8 | 0.7 | 14.0 |
| example 4 | | | | | | | | |
| Inventive | 6.5 | 1.6 | 10.8 | 10.1 | 1.6 | 6.0 | 0.7 | 7.5 |
| example 5 | | | | | | | | |
| Inventive | 4.8 | 1.9 | 3.2 | 16.2 | 1.0 | 8.8 | 1.9 | 16.9 |
| example 6 | | | | | | | | |
| Inventive | 8.4 | 2.6 | 16.5 | 8.1 | 1.1 | 5.1 | 2.8 | 4.3 |
| example 7 | | | | | | | | |
| Inventive | 1.1 | 3.6 | 4.3 | 5.0 | 2.9 | 3.8 | 0.5 | 19.2 |
| example 8 | | | | | | | | |
| Inventive | 4.0 | 3.5 | 17.0 | 16.0 | 1.8 | 7.3 | 1.5 | 15.9 |
| example 9 | | | | | | | | |
| Inventive | 7.7 | 4.3 | 4.8 | 12.0 | 2.4 | 6.4 | 0.2 | 15.5 |
| example 10 | | | | | | | | |
| Inventive | 3.5 | 3.7 | 4.6 | 13.5 | 3.4 | 5.6 | 0.2 | 7.7 |
| example 11 | | | | | | | | |
| Inventive | 3.8 | 3.1 | 15.6 | 1.3 | 4.1 | 5.6 | 2.7 | 5.6 |
| example 12 | | | | | | | | |
| Inventive | 9.7 | 0.2 | 17.4 | 10.9 | 1.2 | 5.0 | 1.0 | 12.6 |
| example 13 | | | | | | | | |
| Inventive | 9.4 | 2.7 | 6.7 | 13.6 | 2.5 | 9.6 | 0.3 | 6.4 |
| example 14 | | | | | | | | |
| Inventive | 5.4 | 2.6 | 1.3 | 9.6 | 3.2 | 4.6 | 0.6 | 6.5 |
| example 15 | | | | | | | | |
| Inventive | 2.2 | 4.5 | 6.8 | 19.0 | 0.6 | 1.3 | 1.0 | 10.0 |
| example 16 | | | | | | | | |

TABLE 2

| | | | | | | Long- | | |
|---|---|---|---|---|---|---|---|---|
| | | | | | | term | | |
| | Trivalent | | | Corrosion | Point | corrosion | | |
| | chromium | Acidity | Adhesion | resistance | corrosion | resistance | | Co- |
| Classification | compound | regulator | improver | improver | improver | improver | Lubricant | solvent |
| Comparative | 0.8 | 1.9 | 3.5 | 15.9 | 3.6 | 6.5 | 1.7 | 18.2 |
| example 1 | | | | | | | | |
| Comparative | 11.2 | 3.3 | 7.3 | 17.1 | 0.6 | 8.8 | 0.6 | 3.4 |
| example 2 | | | | | | | | |
| Comparative | 1.2 | 0.0 | 10.2 | 5.6 | 2.2 | 4.0 | 2.3 | 17.9 |
| example 3 | | | | | | | | |
| Comparative | 2.8 | 7.3 | 11.6 | 19.5 | 2.5 | 6.0 | 1.5 | 1.7 |
| example 4 | | | | | | | | |
| Comparative | 4.5 | 4.2 | 0.8 | 3.8 | 2.8 | 4.8 | 1.1 | 15.2 |
| example 5 | | | | | | | | |
| Comparative | 8.4 | 0.4 | 21.0 | 2.7 | 4.6 | 6.1 | 1.9 | 10.1 |
| example 6 | | | | | | | | |
| Comparative | 3.6 | 1.8 | 8.0 | 0.3 | 0.5 | 7.5 | 1.0 | 7.3 |
| example 7 | | | | | | | | |
| Comparative | 9.0 | 4.4 | 13.3 | 23.0 | 0.9 | 4.3 | 0.8 | 5.0 |
| example 8 | | | | | | | | |
| Comparative | 9.4 | 2.7 | 13.2 | 1.3 | 0.0 | 3.6 | 1.9 | 18.6 |
| example 9 | | | | | | | | |
| Comparative | 1.6 | 3.7 | 8.9 | 12.1 | 6.2 | 4.2 | 0.3 | 17.9 |
| example 10 | | | | | | | | |
| Comparative | 6.4 | 3.8 | 1.1 | 18.1 | 0.4 | 0.3 | 0.7 | 4.0 |
| example 11 | | | | | | | | |
| Comparative | 3.1 | 3.8 | 5.3 | 10.2 | 2.2 | 11.3 | 2.5 | 7.9 |
| example 12 | | | | | | | | |
| Comparative | 3.1 | 1.3 | 2.6 | 2.8 | 2.4 | 3.6 | 0.0 | 12.0 |
| example 13 | | | | | | | | |
| Comparative | 7.2 | 4.2 | 4.5 | 14.7 | 2.2 | 4.9 | 4.2 | 8.0 |
| example 14 | | | | | | | | |
| Comparative | 8.6 | 4.5 | 3.4 | 19.4 | 4.0 | 4.5 | 1.9 | 0.1 |
| example 15 | | | | | | | | |
| Comparative | 2.3 | 2.3 | 17.1 | 1.0 | 1.9 | 6.6 | 0.3 | 30.0 |
| example 16 | | | | | | | | |

Using the surface treatment solution composition manufactured as above, a ternary system zinc alloy-plated steel sheet sample including, by weight % Mg: 4.0 to 7.0%, Al: 11.0 to 19.5%, and a balance of Zn and inevitable impurities was cut to 7 cm×15 cm (width×length), degreased, and bar-coated to produce a sample such that the passive film coating amount was approximately 35 mg/m² (approximately 0.4 μm thickness level) based on Cr. In this case, drying was performed at 50 °C.

To measure the properties of the solution composition and the plated steel sheet surface-treated using the same sample manufactured as above, solution stability, flat sheet corrosion resistance, processed portion corrosion resistance, vascular oil penetration, alkali resistance, point corrosion resistance, blackening resistance, foreign object defect, and long-term corrosion resistance were measured using the methods and criteria as below.

### Solution Stability

Immediately after manufacturing the coating composition manufactured by the above method, initial viscosity (Vi) was measured, the composition was stored in an oven at 50 °C for 120 hours and cooled back to 25 °C, the final viscosity (Vl) at 25 °C was measured, and was added to mathematical expression 1 as below, and the results were evaluated according to the evaluation criteria as below.

ΔV=(Vl−Vi)/Vi×100(%) [Equation 1]

### <Evaluation Criteria for Solution Stability>

∘: ΔV is less than 20(%) or no gelation is observed with the naked eye
x: ΔV is 20(%) or more or gelation is observed with the naked eye

### Flat Sheet Corrosion Resistance

In accordance with the method specified in ASTM B117, the solution composition was treated with respect to each steel sheet (sample), and the white rust rate of the steel sheet over time was measured.

### <Evaluation Criteria for Flat Sheet Corrosion Resistance>

∘: White rust occurrence time is 144 hours or more
Δ: White rust occurrence time is 96 hours or more less than 144 hours
x: White rust occurrence time is less than 96 hours

### Processed Portion Corrosion Resistance

The surface-treated steel sheet (sample) as above was pushed up to a height of 6 mm using an Erichsen tester, and the degree of white rust occurrence was measured after 24 hours.

### <Evaluation Criteria for Processed Portion Corrosion Resistance>

∘: No white rust, or when occurs, relatively slight
Δ: White rust occurs in circle and flows, but does not flow out
x: White rust occurs and flows out of circle

### Pipe Forming Oil Invasiveness

The surface-treated steel sheet (sample) as above was immersed in the forming oil at room temperature and held for 24 hours, and the color difference before and after the immersion was measured. In this case, the forming oil was 10% diluted in water using domestically produced BW WELL MP-411.

### <Evaluation Criteria for Pipe Forming Oil Invasiveness>

∘: ΔE≤2
Δ: 2<ΔE≤3
x: 3<ΔE

### Alkali Resistance

The surface-treated steel sheet (sample) as above was immersed in a 60 °C degreasing solution for 2 minutes, washed with water and air-blown, and the color difference before and after was measured. In this case, as the alkaline degreasing solution, Finecleaner L 4460 A: 20 g/2.4 L+L 4460 B: 12 g/2.4 L (pH=12) from Parkerizing was used.

### <Evaluation Criteria for Alkali Resistance>

∘: ΔE 2
Δ: 2<ΔE 4
x: 4<ΔE

### Point Corrosion Resistance

The surface of the surface-treated steel sheet (sample) as above was sprayed using a sprayer to form dew, and the two spray-treated steel sheets were placed to oppose each other and packaged, and put in a constant temperature and humidity chamber. 6 hours at high temperature and humidity (42 °C, 95%) and 6 hours at low temperature and humidity (15 °C, 60%) was one cycle, and 8 cycles were performed, and the number of pit defects on the surface was measured. In this case, the scan area of the steel sheet was determined to be 150×50 mm², magnified 100 times and only the number of pit defects of a corrosive pit defect area of 29500 μm² or more was counted.

### <Evaluation Criteria for Point Corrosion Resistance>

∘: Number of pits≤20
Δ: 20<Number of pits≤40
x: 40<Number of pits

### Blackening Resistance

To evaluate blackening resistance of the steel sheet, the color difference of the steel sheet treated with the trivalent chromium surface treatment composition was measured, and the steel sheet was placed in a constant temperature and humidity chamber and held at a temperature of 50 °C and a relative humidity of 95% for 120 hours, the steel sheet was taken out and the color difference was measured.

### <Evaluation Criteria for Blackening Resistance>

∘: ΔE≤3
Δ: 3<ΔE≤5
x: 5<ΔE

### Foreign Object Defect

To evaluate the foreign object defect of the steel sheet treated with the surface treatment composition, a white gauze was covered on a probe with a surface area of approximately 4 4 cm², a 10 kg weight was placed on the probe, was rubbed back and forth 100 times, and the whiteness value of the gauze before and after rubbing (ΔL=L_{before}−L_{after}) was measured. In this case, to simulate high humidity conditions, the steel sheet and the probe were placed in a humidity chamber and the friction evaluation was conducted while maintaining the humidity at 95% or more with a humidifier.

### <Evaluation Criteria for Foreign Object Defect>

∘: ΔL≤2.5
Δ: 2.5<ΔL≤5
x: 5≤ΔL

### Long-Term Corrosion Resistance

To evaluate long-term corrosion resistance, the steel sheet treated with the surface treatment composition went through a cyclic corrosion test [Salt spray 2 hr (5% NaCl, 35 °C)→Drying 4 hr (25% RH, 60 °C)→Humid 2 hr (95% RH, 50 °C)] according to [ISO 14993], and the time until red rust occurred was measured. In this case, the plating coating amount of the plated steel sheet was 150 g/m² per cross-section.

### <Evaluation Criteria for Long-Term Corrosion Resistance>

∘: 200≤days red rust occurrence time point
Δ: 150 days<red rust occurrence time point≤200 days
x: red rust occurrence time point<150 days

The properties measurement results are listed in Tables 3 and 4 below.

TABLE 3

| | | Flat | Processed | Pipe | | | | | Long- |
|---|---|---|---|---|---|---|---|---|---|
| | | sheet | portion | forming | | Point | | Foreign | term |
| | Solution | corrosion | corrosion | oil | Alkali | corrosion | Blackening | object | corrosion |
| Classification | stability | resistance | resistance | invasiveness | resistance | resistance | resistance | defect | resistance |
| Inventive | ∘ | ∘ | ∘ | ∘ | ∘ | ∘ | ∘ | ∘ | ∘ |
| example 1 | | | | | | | | | |
| Inventive | ∘ | ∘ | ∘ | ∘ | ∘ | ∘ | ∘ | ∘ | ∘ |
| example 2 | | | | | | | | | |
| Inventive | ∘ | ∘ | ∘ | ∘ | ∘ | ∘ | ∘ | ∘ | ∘ |
| example 3 | | | | | | | | | |
| Inventive | ∘ | ∘ | ∘ | ∘ | ∘ | ∘ | ∘ | ∘ | ∘ |
| example 4 | | | | | | | | | |
| Inventive | ∘ | ∘ | ∘ | ∘ | ∘ | ∘ | ∘ | ∘ | ∘ |
| example 5 | | | | | | | | | |
| Inventive | ∘ | ∘ | ∘ | ∘ | ∘ | ∘ | ∘ | ∘ | ∘ |
| example 6 | | | | | | | | | |
| Inventive | ∘ | ∘ | ∘ | ∘ | ∘ | ∘ | ∘ | ∘ | ∘ |
| example 7 | | | | | | | | | |
| Inventive | ∘ | ∘ | ∘ | ∘ | ∘ | ∘ | ∘ | ∘ | ∘ |
| example 8 | | | | | | | | | |
| Inventive | ∘ | ∘ | ∘ | ∘ | ∘ | ∘ | ∘ | ∘ | ∘ |
| example 9 | | | | | | | | | |
| Inventive | ∘ | ∘ | ∘ | ∘ | ∘ | ∘ | ∘ | ∘ | ∘ |
| example 10 | | | | | | | | | |
| Inventive | ∘ | ∘ | ∘ | ∘ | ∘ | ∘ | ∘ | ∘ | ∘ |
| example 11 | | | | | | | | | |
| Inventive | ∘ | ∘ | ∘ | ∘ | ∘ | ∘ | ∘ | ∘ | ∘ |
| example 12 | | | | | | | | | |
| Inventive | ∘ | ∘ | ∘ | ∘ | ∘ | ∘ | ∘ | ∘ | ∘ |
| example 13 | | | | | | | | | |
| Inventive | ∘ | ∘ | ∘ | ∘ | ∘ | ∘ | ∘ | ∘ | ∘ |
| example 14 | | | | | | | | | |
| Inventive | ∘ | ∘ | ∘ | ∘ | ∘ | ∘ | ∘ | ∘ | ∘ |
| example 15 | | | | | | | | | |
| Inventive | ∘ | ∘ | ∘ | ∘ | ∘ | ∘ | ∘ | ∘ | ∘ |
| example 16 | | | | | | | | | |

TABLE 4

| | | Flat | Processed | Pipe | | | | | Long- |
|---|---|---|---|---|---|---|---|---|---|
| | | sheet | portion | forming | | Point | | Foreign | term |
| | Solution | corrosion | corrosion | oil | Alkali | corrosion | Blackening | object | corrosion |
| Classification | stability | resistance | resistance | invasiveness | resistance | resistance | resistance | defect | resistance |
| Comparative | ∘ | x | x | ∘ | ∘ | x | ∘ | ∘ | x |
| example 1 | | | | | | | | | |
| Comparative | ∘ | ∘ | ∘ | ∘ | ∘ | ∘ | ∘ | x | ∘ |
| example 2 | | | | | | | | | |
| Comparative | x | ∘ | x | ∘ | x | x | x | ∘ | x |
| example 3 | | | | | | | | | |
| Comparative | ∘ | x | x | ∘ | ∘ | x | ∘ | ∘ | x |
| example 4 | | | | | | | | | |
| Comparative | ∘ | ∘ | ∘ | ∘ | ∘ | ∘ | ∘ | x | ∘ |
| example 5 | | | | | | | | | |
| Comparative | ∘ | x | x | ∘ | ∘ | x | ∘ | ∘ | x |
| example 6 | | | | | | | | | |
| Comparative | ∘ | x | x | ∘ | ∘ | x | x | ∘ | x |
| example 7 | | | | | | | | | |
| Comparative | x | x | x | ∘ | ∘ | x | x | ∘ | x |
| example 8 | | | | | | | | | |
| Comparative | ∘ | ∘ | ∘ | ∘ | ∘ | x | ∘ | ∘ | ∘ |
| example 9 | | | | | | | | | |
| Comparative | x | ∘ | x | x | ∘ | ∘ | x | x | x |
| example 10 | | | | | | | | | |
| Comparative | ∘ | ∘ | ∘ | ∘ | ∘ | ∘ | ∘ | ∘ | x |
| example 11 | | | | | | | | | |
| Comparative | ∘ | ∘ | ∘ | ∘ | ∘ | ∘ | ∘ | x | ∘ |
| example 12 | | | | | | | | | |
| Comparative | ∘ | ∘ | ∘ | ∘ | ∘ | ∘ | ∘ | x | ∘ |
| example 13 | | | | | | | | | |
| Comparative | x | ∘ | ∘ | ∘ | ∘ | ∘ | ∘ | ∘ | ∘ |
| example 14 | | | | | | | | | |
| Comparative | ∘ | x | x | ∘ | ∘ | ∘ | ∘ | ∘ | x |
| example 15 | | | | | | | | | |
| Comparative | x | ∘ | x | ∘ | ∘ | ∘ | x | ∘ | x |
| example 16 | | | | | | | | | |

As for invention examples 1 to 16 according to the present disclosure, solution stability, flat sheet corrosion resistance, processed portion corrosion resistance, pore penetration resistance, alkali resistance, point corrosion resistance, blackening resistance, long-term corrosion resistance, and the foreign object defect were excellent.

As for comparative example 1, the content of the trivalent chromium compound was insufficient, such that corrosion resistance due to the barrier effect was deteriorated, such that flat sheet corrosion resistance, processed portion corrosion resistance, point corrosion resistance, and long-term corrosion resistance were insufficient.

As for comparative example 2, the content of the trivalent chromium compound was excessive, such that the foreign object defect occurred.

As for comparative example 3, the content of the acidity regulator was insufficient, such that solution stability was insufficient, and accordingly, flat sheet corrosion resistance, processed portion corrosion resistance, point corrosion resistance, blackening resistance, and long-term corrosion resistance were deteriorated.

As for comparative example 4, the content of the acidity regulator was excessive, such that flat sheet corrosion resistance, processed portion corrosion resistance, point corrosion resistance, and long-term corrosion resistance were insufficient due to residual acid.

As for comparative example 5, the content of the adhesion improver was insufficient, the foreign object defect occurred.

As for comparative example 6, the content of the adhesion improver was excessive, such that flat sheet corrosion resistance, processed portion corrosion resistance, point corrosion resistance, and long-term corrosion resistance were insufficient due to residual unreacted silane.

As for comparative example 7, the content of the corrosion resistance improver is insufficient, such that the flat sheet corrosion resistance, processed portion corrosion resistance, point corrosion resistance, and long-term corrosion resistance were insufficient.

As for comparative example 8, the content of the corrosion resistance improver was excessive, such that solution stability was insufficient due to the high solid content, and accordingly, flat sheet corrosion resistance, processed portion corrosion resistance, point corrosion resistance, blackening resistance, and long-term corrosion resistance were deteriorated.

As for comparative example 9, the content of the point corrosion improver was insufficient, such that point corrosion resistance was deteriorated.

As for comparative example 10, the content of the point corrosion improver was excessive, such that solution stability was insufficient, and accordingly, processed portion corrosion resistance, vascular permeability, blackening resistance, and long-term corrosion resistance were deteriorated.

As for comparative example 11, the long-term corrosion resistance improver content was insufficient, such that long-term corrosion resistance was deteriorated.

As for comparative example 12, the long-term corrosion resistance improver content was excessive, such that the foreign object defect occurred.

As for comparative example 13, the lubricant content was insufficient, such that the foreign object defect occurred.

As for comparative example 14, the lubricant content was excessive, such that solution stability was insufficient, and accordingly, processed portion corrosion resistance and long-term corrosion resistance were deteriorated.

As for comparative example 15, the co-solvent content was insufficient, such that surface defect occurred, and accordingly, flat sheet corrosion resistance, processed portion corrosion resistance, and long-term corrosion resistance were deteriorated.

As for comparative example 16, the content of the co-solvent was excessive, such that solution stability was insufficient, and accordingly, processed portion corrosion resistance, blackening resistance and long-term corrosion resistance were deteriorated.

1. A surface treatment solution composition, comprising:
1 to 10 weight % of a trivalent chromium compound,
0.1 to 5 weight % of an acidity regulator,
1 to 20 weight % of an adhesion improver,
1 to 20 weight % of a corrosion resistance improver,
0.1 to 5.0 weight % of a point corrosion improver,
1 to 10 weight % of a long-term corrosion resistance improver,
0.1 to 3.0 weight % of a lubricant,
1 to 20 weight % of a co-solvent, and
a remainder of solvent.

2. The surface treatment solution composition of claim 1, wherein the trivalent chromium compound is one or more selected from a group consisting of chromium sulfate, chromium nitrate, chromium phosphate, chromium fluoride and mixtures thereof.

3. The surface treatment solution composition of claim 1, wherein the acidity regulator is one or more selected from a group consisting of phosphoric acid, nitric acid, sulfuric acid, hydrofluoric acid, hydrochloric acid, (NH₄)H₂PO₄, (NH₄)₂HPO₄, NaH₂PO₄, Na₂HPO₄, phytic acid, glycolic acid, lactic acid, acetic acid, oxalic acid and mixtures thereof.

4. The surface treatment solution composition of claim 1, wherein the adhesion improver is one or more selected from a group consisting of vinylmethoxy silane, vinyltrimethoxy silane (VTMS), vinylethoxy silane, vinyltriethoxy silane, 3-aminopropyltriethoxy silane, 3-glycidoxypropyltrimethoxy silane, 3-metaglyoxypropyltrimethoxy silane, γ-glycidoxypropyltriethoxysilane, γ-glycidoxytrimethyldimethoxysilane, N-(3-(trimethoxysilyl)propyl)ethylenediamine (AEAPTMS), 2-(3,4-Epoxycyclohexyl)ethyltrimethoxysilane, 2-(3,4-Epoxycyclohexyl)ethyltriethoxysilane, 3-(2,3-Epoxypropoxy)propyltrimethoxysilane, 3-(2,3-Epoxypropoxy)propyltriethoxysilane, 3-(2,3-Epoxypropoxy)propylmethyldiethoxysilane, 3-(2,3-Epoxypropoxy)propylmethyldimethoxysilane, 3-Aminopropyltriethoxysilane, 3-Aminopropyltrimethoxysilane, 3-Amonopropylmethydiethoxysilane, N-(2-Aminoethyl-3-aminopropyl)methyldimethoxysilane, N-(2-Aminoethyl-3-aminopropyl)trimethoxysilane, diethylenetriaminopropyltrimethoxysilane, 3-Ureidopropyltrimethoxysilane, N-Phenylaminopropyltrimethoxysilane, (3-Glycidyloxypropyl)trimethoxysilane(GPTMS), and methyltrimethoxysilane(MTMS).

5. The surface treatment solution composition of claim 1, wherein the corrosion resistance improver is one or more selected from a group consisting of vanadyl acetylacetonate, ammonium metavanadate, potassium metavanadate, sodium metavanadate, vanadium trioxide, vanadium acetylacetonate, ammonium metavanadate, silicon oxide and mixtures thereof.

6. The surface treatment solution composition of claim 1, wherein the point corrosion improver is one or more selected from a group consisting of ethylenediamine, hexamethylenediamine, trimethylamine, methylamine, diphenylamine, ethyleneamine, aniline, toluidine, piperidine, aziridine, pyridine, alanine, propylamine, diisopropylamine, monoisopropylamine, dibutylamine, dipropylamine and mixtures thereof.

7. The surface treatment solution composition of claim 1, wherein the long-term corrosion resistance improver is one or more selected from a group consisting of chromium chloride anhydrous, chromium chloride pentahydrate, chromium chloride hexahydrate, chromium chloride nonahydrate and mixtures thereof.

8. The surface treatment solution composition of claim 1, wherein the lubricant is one or more selected from a group consisting of polytetrafluoroethylene (PTFE), polyethylene (PE), carnauba wax and mixtures thereof.

9. The surface treatment solution composition of claim 1, wherein the co-solvent is one or more selected from a group consisting of ethanol, isopropyl alcohol, methanol, tallow alcohol, 2-butoxyethanol, diethylene glycol monobutyl ether and mixtures thereof.

10. A surface-treated plated steel sheet, comprising:
a steel sheet;
a plating layer formed on at least one surface of the steel sheet; and
a surface-treated coating layer formed on the plating layer,
wherein the surface-treated coating layer is formed by the solution composition of claim 1.

11. The surface-treated plated steel sheet of claim 10, wherein the plating layer comprises, by weight %, magnesium (Mg): 4.0 to 7.0%, aluminum (Al): 11.0 to 19.5%, and a balance of Zn and inevitable impurities.

12. The surface-treated plated steel sheet of claim 11, wherein the plating layer satisfies relational expression 1 as below:
0.26≤I(110)/I(103)≤0.65 [Relational expression 1]
where I(110) represents X-ray diffraction integral intensity of an (110) plane crystal peak for a MgZn₂ phase, and I(103) represents X-ray diffraction integral intensity of an (103) plane crystal for a MgZn₂ phase.

13. The surface-treated plated steel sheet of claim 10, wherein the surface-treated coating layer has a thickness of 0.1 to 2.0 μm.

14. A method for manufacturing a surface-treated plated steel sheet, the method comprising:
providing a zinc alloy plated steel sheet having a plating layer formed on at least one surface thereof,
coating the plating layer with a solution composition of claim 1; and
drying the coated steel sheet.

15. The method of claim 14, wherein the coating is performed by a method selected from a group consisting of bar coating, roll coating, spraying, dipping, spray squeezing and dipping squeezing.

16. The method of claim 14, wherein the drying is performed in a temperature range of 40 to 280 °C based on a peak metal temperature (PMT) of the steel sheet.
